(19) United States
(12) Patent Application Publication
(10) Pub. No.: US 2014/0118423 A1
(43) Pub. Date: May 1, 2014

(54) LIQUID CRYSTAL DISPLAY APPARATUS

(71) Applicants: Makoto Hasegawa, Osaka-shi (JP); Kazunari Tomizawa, Osaka-shi (JP); Tomohiko Mori, Osaka-shi (JP); Yuichi Yoshida, Osaka-shi (JP)

(72) Inventors: Makoto Hasegawa, Osaka-shi (JP); Kazunari Tomizawa, Osaka-shi (JP); Tomohiko Mori, Osaka-shi (JP); Yuichi Yoshida, Osaka-shi (JP)

(73) Assignee: SHARP KABUSHIKI KAISHA, Osaka-shi, Osaka (JP)

(21) Appl. No.: 14/128,643

(22) PCT Filed: Jun. 22, 2012
(86) PCT No.: PCT/JP2012/066024

§ 371 Date: Dec. 23, 2013

(30) Foreign Application Priority Data
Jun. 27, 2011 (JP) 2011-142185

(51) Int. Cl. G09G 3/20

(52) U.S. Cl. CPC G09G 3/2074; G09G 3/2003
USPC 345/690; 345/88

(57) ABSTRACT

Viewing angle characteristics on the entire display surface are improved while suppressing harmful effects such as flicker and banding caused by viewing angle improvement control. A liquid crystal display apparatus (1) includes: a liquid crystal panel (11) which includes a plurality of pixels arranged in a matrix; a drive control unit (24) which performs viewing angle improvement processing by converting a gradation of a video signal input to the pixel; and a processing object determination unit (22) which determines whether or not an image displayed on each of the pixels of the liquid crystal panel (11) is an image having an intermediate color. The drive control unit (24) is configured to perform the viewing angle improvement processing on the pixel determined by the processing object determination unit (22) such that the pixel displays the image having the intermediate color.

### TECHNICAL FIELD

The present invention relates to a liquid crystal display apparatus having a liquid crystal panel.

### BACKGROUND ART

A liquid crystal display apparatus which has a liquid crystal panel and is configured to perform viewing angle improvement of the liquid crystal panel is known. For example, as disclosed in International Publication No. 2010/71221, such a liquid crystal display apparatus is configured to change gradation for each sub-pixel of each pixel by a time-division scheme (for example, for each display frame), that is, to perform so-called time-division gradation control.

### DISCLOSURE OF INVENTION

However, in the case where the time-division gradation control is performed as in the configuration disclosed in International Publication No. 2010/71221, the viewing angle of a display surface can be improved by alternately displaying a high-gradation image and a low gradation-image. However, in the case where the time-division gradation control is performed, the brightness of the gradation of the image is significantly changed, and thus flicker easily occurs.

In order to suppress flicker, a method of performing a high-gradation display in one pixel of pixels adjacent to each other in the liquid crystal panel, performing a low-gradation display in the other pixel, and switching the high-gradation display and the low-gradation display by the time-division scheme for each pixel is considered. Accordingly, the gradation of the image on the entire screen is not significantly changed. Therefore, the occurrence of flicker as described above can be prevented.

However, even in this configuration, depending on the compatibility to polarity inversion performed every two rows to prevent burn-in of liquid crystals, the brightness of the image slightly varies according to the difference in polarity even in the same high-gradation display. In this case, a phenomenon in which the display surface is viewed in a stripe pattern, so-called banding occurs.

An object of the present invention is to improve viewing angle characteristics on the entire display surface while suppressing harmful effects such as flicker and banding caused by viewing angle improvement control in a liquid crystal display apparatus provided with a liquid crystal panel.

A liquid crystal display apparatus according to an aspect of the present invention includes: a liquid crystal panel which includes a plurality of pixels arranged in a matrix; a viewing angle improvement unit which performs a high-gradation display to display an image having a higher gradation than a gradation of an input video on one pixel of pixels adjacent to each other, performs a low-gradation display to display an image having a lower gradation than the gradation of the input video on the other pixel of the pixels adjacent to each other, and switches between the high-gradation display and the low-gradation display on each of the pixels in each display frame to perform viewing angle improvement processing; and a processing object determination unit which determines whether or not an image displayed on each of the pixels of the liquid crystal panel is an image having an intermediate color which is an object of the viewing angle improvement processing, wherein the viewing angle improvement unit is configured to perform the viewing angle improvement processing on the pixel determined by the processing object determination unit such that the pixel displays the image having the intermediate color.

According to the aspect of the present invention, in the liquid crystal display apparatus, the viewing angle characteristics on the entire display surface can be improved while suppressing harmful effects such as flicker and banding caused by viewing angle improvement control.

### BRIEF DESCRIPTION OF DRAWINGS

FIG. 1 is a block diagram illustrating a schematic configuration of a liquid crystal display apparatus according to a first embodiment.

FIG. 2 is a diagram illustrating a difference in gradation level by a difference in viewing direction of a display surface.

FIG. 3 is a diagram schematically illustrating viewing angle improvement control.

FIG. 4 is a flowchart illustrating an operation of a viewing angle improvement circuit.

FIG. 5 is a diagram illustrating an example of gradation conversion in a case of displaying an image having an intermediate color.

FIG. 6 is a diagram illustrating an example of the gradation conversion in a case of displaying an image of a color other than the intermediate color.

FIG. 7 is a block diagram illustrating a schematic configuration of a liquid crystal display apparatus according to a second embodiment.

FIG. 8 is a block diagram illustrating a schematic configuration of a processing object determination unit.

FIG. 9 is a diagram illustrating an example of gradation conversion in a case of displaying a high-gradation image.

FIG. 10 is a diagram illustrating an example of the gradation conversion in a case of displaying a low-gradation image.

FIG. 11 is a diagram illustrating an example of obtaining a gradation of an output video signal corresponding to a gradation of an input video signal through linear interpolation.

FIG. 12 is a diagram illustrating an operation of a viewing angle improvement circuit.

FIG. 13 is a block diagram illustrating a schematic configuration of a processing object determination unit of a liquid crystal display apparatus according to a third embodiment.

FIG. 14 is a block diagram illustrating a state of gradation conversion for each sub-pixel.

### DESCRIPTION OF EMBODIMENTS

A liquid crystal display apparatus according to an embodiment of the present invention includes: a liquid crystal panel which includes a plurality of pixels arranged in a matrix; a viewing angle improvement unit which performs a high-gradation display to display an image having a higher gradation than a gradation of an input video on one pixel of pixels adjacent to each other, performs a low-gradation display to display an image having a lower gradation than the gradation of the input video on the other pixel of the pixels adjacent to each other, and switches between the high-gradation display and the low-gradation display on each of the pixels in each display frame to perform viewing angle improvement processing; and a processing object determination unit which determines whether or not an image displayed on each of the pixels of the liquid crystal panel is an image having an intermediate color which is an object of the viewing angle improvement processing, wherein the viewing angle improvement unit is configured to perform the viewing angle improvement processing on the pixel determined by the processing object determination unit such that the pixel displays the image having the intermediate color (first configuration).

According to the configuration, since the viewing angle improvement processing is performed only on the pixel determined by the processing object determination unit such that the pixel displays the image having the intermediate color which is the object of the viewing angle improvement processing, a viewing angle improvement in a part which displays the intermediate color having a high viewing angle improvement effect can be achieved. In contrast, on a part which displays a pure color or a white color having a low viewing angle improvement effect, the above-described viewing angle improvement processing of performing the high-gradation display and the low-gradation display on the pixels adjacent to each other and switching between the high-gradation display and the low-gradation display in each display frame is not performed. Therefore, in the part which displays the pure color or the white color, harmful effects such as flicker and banding caused by the above-described viewing angle improvement processing can be prevented.

Accordingly, a viewing angle improvement effect in the entire display surface can be obtained to be as high as possible while suppressing the harmful effects caused by the viewing angle improvement processing as much as possible.

Here, the intermediate color means a color other than a color which is recognized as white by a viewer (hereinafter, simply referred to as white color) and a color which is recognized as a pure color having high saturation by the viewer (hereinafter, simply referred to as pure color) when the liquid crystal panel is viewed.

In the first configuration, the processing object determination unit determines whether or not the image has the intermediate color on the basis of a weighting coefficient according to the image displayed on each of the pixels (second configuration).

Accordingly, the processing object determination unit can easily determine whether or not the image has the intermediate color as the object of the viewing angle improvement processing by using the weighting coefficient.

In the second configuration, the weighting coefficient is a coefficient according to saturation obtained from a video signal input to each of the pixels of the liquid crystal panel, and the processing object determination unit includes a saturation determination unit which determines whether or not the image has the intermediate color on the basis of the weighting coefficient (third configuration).

Accordingly, the determination of whether or not the image has the intermediate color as the object of the viewing angle improvement processing can be easily performed on the basis of the saturation obtained from the video signal.

In the third configuration, the viewing angle improvement unit includes: a gradation conversion unit which obtains output gradations for the high-gradation display and the low-gradation display according to the saturation for the pixel determined by the processing object determination unit such that the pixel displays the image having the intermediate color; and a drive control unit which performs the viewing angle improvement processing according to the output gradations output from the gradation conversion unit (fourth configuration).

In this manner, in the pixel which is the object of the viewing angle improvement processing, the gradations for the high-gradation display and the low-gradation display are changed according to the saturation of the image. Accordingly, a higher viewing angle improvement effect can be obtained by the viewing angle improvement processing.

In the second configuration, the weighting coefficient is a coefficient according to saturation and hue obtained from a video signal input to each of the pixels of the liquid crystal panel, the processing object determination unit is configured to determine whether or not the image has the intermediate color of a hue of the object of the viewing angle improvement processing on the basis of the weighting coefficient, and the viewing angle improvement unit performs the viewing angle improvement processing on the pixel which displays the image having the intermediate color of the hue of the object of the viewing angle improvement processing on the basis of the determination result of the processing object determination unit (fifth configuration).

Accordingly, the viewing angle improvement processing can be performed also in consideration of hue. Therefore, the viewing angle improvement processing can be performed only in the case where the intermediate color of the hue of the object of the viewing angle improvement processing is displayed.

In the fifth configuration, the weighting coefficient is an intermediate color determination coefficient, the processing object determination unit further includes a coefficient calculation unit which obtains the intermediate color determination coefficient on the basis of the saturation and the hue, and the viewing angle improvement unit includes: a gradation conversion unit which respectively obtains output gradations for the high-gradation display and the low-gradation display by using the intermediate color determination coefficient; and a drive control unit which performs the viewing angle improvement processing according to the output gradations output from the gradation conversion unit (sixth configuration).

In this manner, by using the intermediate color determination coefficient in consideration saturation and hue, the output gradations for the high-gradation display and the low-gradation display for the viewing angle improvement processing can be easily calculated. In addition, since differences in gradation during the viewing angle improvement control are determined according to the saturation and the hue, an appropriate viewing angle improvement can be efficiently performed while suppressing the harmful effects such as flicker and banding caused by the viewing angle improvement control as much as possible.

In the sixth configuration, the coefficient calculation unit calculates the intermediate color determination coefficient for each of the sub-pixels on the basis of a signal input to each of the sub-pixels in the video signals input to each of the pixels, and the gradation conversion unit calculates the output gradation for each of the sub-pixels by using the intermediate color determination coefficient of each of the sub-pixels (seventh configuration).

Accordingly, the viewing angle improvement control can be independently performed on each of the sub-pixels according to the hue and saturation of the image displayed on each of the sub-pixels. Therefore, the viewing angle improvement control can be performed in more detail. Therefore, a more appropriate viewing angle improvement control can be performed while suppressing the harmful effects caused by the viewing angle improvement control as much as possible.

Hereinafter, exemplary embodiments of a liquid crystal display apparatus of the present invention will be described with reference to the drawings. In addition, the dimensions of constituent members in each of the drawings do not thoroughly represent the dimensions of actual constituent members and dimension ratios between the constituent members, and the like.

### First Embodiment

### <Overall Configuration>

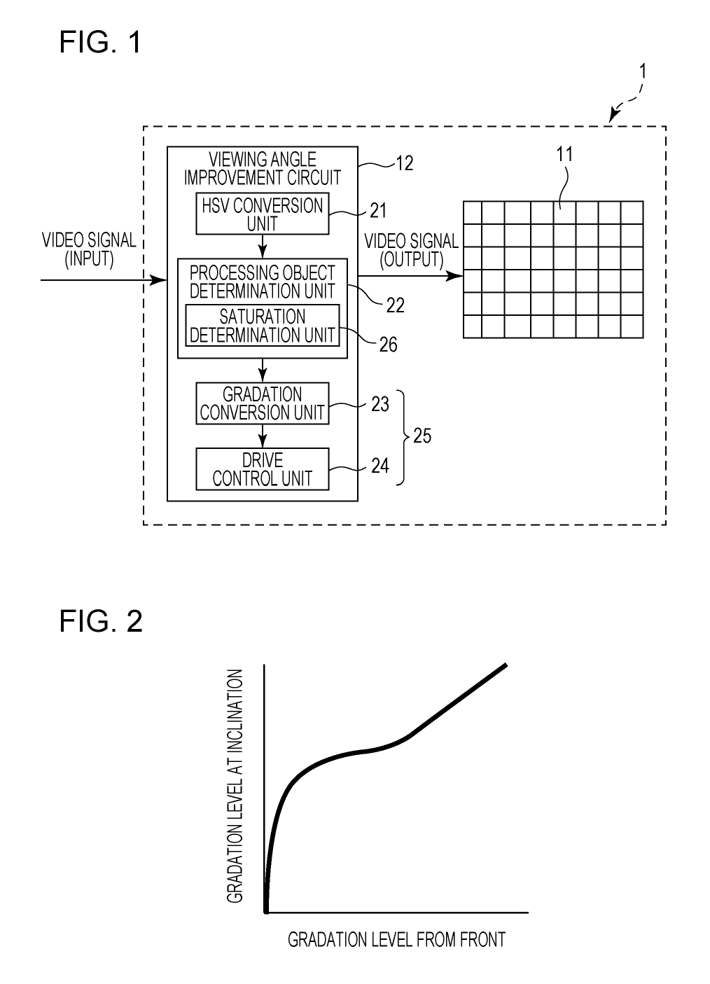

FIG. 1 illustrates a schematic configuration of a liquid crystal display apparatus 1 according to a first embodiment of the present invention. The liquid crystal display apparatus 1 includes a liquid crystal panel 11 and a viewing angle improvement circuit 12 for performing viewing angle improvement control of the liquid crystal panel 11. As described later in detail, the liquid crystal display apparatus 1 changes the gradation of an image displayed in each pixel of the liquid crystal panel 11 from the gradation of an input video signal. Accordingly, in the liquid crystal display apparatus 1, viewing angle characteristics of a display surface of the liquid crystal panel 11 can be improved.

In addition, in FIG. 1, the illustration of a source driver, a gate driver, and the like for driving the liquid crystal panel 11 and the illustration of various signals such as a vertical synchronizing signal and a horizontal synchronizing signal input to the drivers are omitted. In addition, although not particularly illustrated, in the liquid crystal display apparatus 1, a backlight is disposed in the thickness direction of the liquid crystal panel 11.

Although not particularly illustrated, the liquid crystal panel 11 includes an active-matrix substrate in which a plurality of pixels are arranged in a matrix, a counter substrate which is disposed to oppose the active-matrix substrate, and a liquid crystal layer which is enclosed between the substrates. In addition, the liquid crystal panel 11 may be, for example, a transmissive liquid crystal panel, or may be a reflective or semi-reflective liquid crystal panel. That is, the liquid crystal panel 11 may have any configuration as long as the configuration displays a video.

In the active-matrix substrate, although not particularly illustrated, thin film transistors as switching elements, pixel electrodes, and a plurality of rows of gate lines and a plurality of columns of source lines which are arranged in a lattice pattern to surround them are provided.

The counter substrate is disposed at a position opposing at least the pixel electrode with respect to the active-matrix substrate. In the counter substrate, counter electrodes are provided. Each pixel is formed by the counter electrode, the pixel electrode of the active-matrix substrate, and the liquid crystal layer interposed therebetween. In addition, although not particularly illustrated, each pixel of the liquid crystal panel 11 has RGB sub-pixels.

A gate electrode of the thin film transistor in the active-matrix substrate is connected to the gate driver via the gate line. Therefore, when a gate voltage is output from the gate driver to the gate line, the thin film transistor connected to the gate line is in a selected state. In addition, the gate driver outputs the gate voltage on the basis of the vertical synchronizing signal.

In contrast, a source electrode of the thin film transistor is connected to the source driver via the source line. The source driver generates a gradation display signal which is necessary for the gradation display of a video on the basis of the input video signal. Accordingly, when the gradation display signal is output as a drive voltage from the source driver to the source line, the voltage is applied to the liquid crystals of each pixel via the thin film transistor which is connected to the gate line selected by the gate driver. That is, the source driver enables the gradation display of each pixel by outputting the drive voltage corresponding to each of the gate lines on the basis of the video signal. In addition, the source driver outputs the drive voltage on the basis of the horizontal synchronizing signal.

### <Viewing Angle Improvement Circuit>

The viewing angle improvement circuit 12 converts the gradation of the video signal input to the liquid crystal panel 11 so as to improve the viewing angle characteristics in the display surface of the liquid crystal panel 11. That is, the viewing angle improvement circuit 12 converts the gradation the original video signal to be output to the liquid crystal panel 11 so as to improve the viewing angle characteristics in the display surface of the liquid crystal panel 11.

Here, the viewing angle characteristics of the liquid crystal panel 11 will be described with reference to FIG. 2. In the liquid crystal panel 11, a voltage is applied to the liquid crystal layer to change an orientation state of liquid crystal molecules in the liquid crystal layer, thereby adjusting the transmittance of light. In the liquid crystal panel 11, the orientation state of the liquid crystal molecules is relatively changed by a viewing direction with respect to the display surface, and thus the viewing angle is narrower than those of other display apparatuses. For example, as illustrated in FIG. 2, a gradation level (gradation level from front) in a case where the display surface is viewed from the front and a gradation level (gradation level at inclination) in a case where the display surface is viewed in an inclined direction (for example, at 45 degrees) are different gradation levels.

In order to improve the viewing angle characteristics of the liquid crystal panel 11, the viewing angle improvement circuit 12 performs the following viewing angle improvement control.

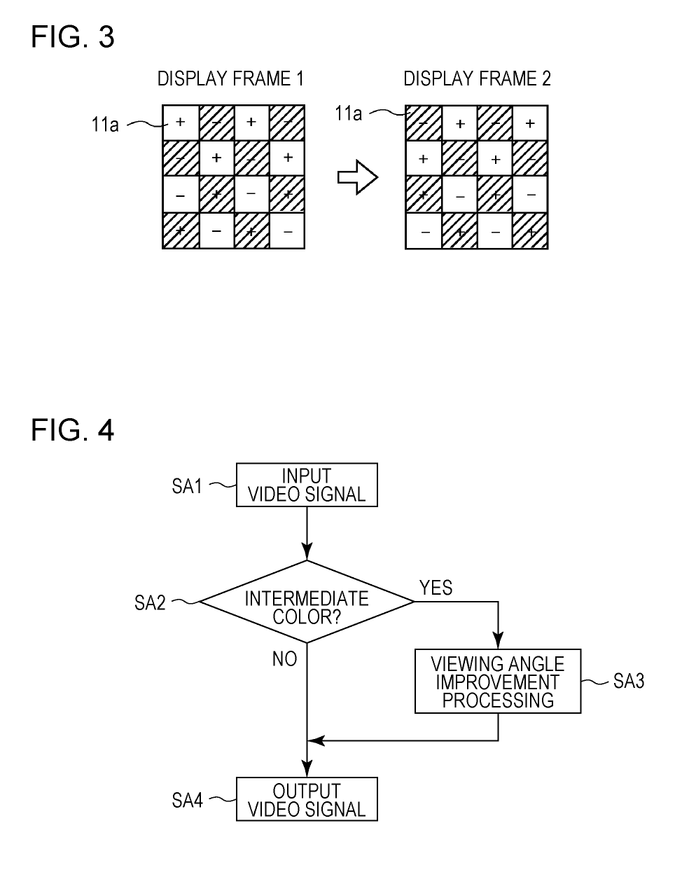

As illustrated in FIG. 3, the viewing angle improvement circuit 12 is configured to respectively perform a high-gradation display (hatched part in FIG. 3) and a low-gradation display (white part in FIG. 3) on pixels 11a adjacent to each other in the display surface and to switch between the high-gradation display and the low-gradation display in each display frame. That is, as illustrated in FIG. 3, in the display surface of the liquid crystal panel 11, the high-gradation display and the low-gradation display alternately appear in the pixels 11a adjacent to each other. In addition, at each display frame (display frames 1 and 2), positions of the pixels which perform the high-gradation display and positions of the pixels which perform the low-gradation display are switched.

Since the viewing angle improvement circuit 12 performs the control as described above, at each display frame, the gradation or color in each pixel 11a is converted so as not to be significantly different even when viewed in the inclined direction. Therefore, the viewing angle characteristics of the liquid crystal panel 11 are improved. Even when the control is performed, since an image display having an average gradation is recognized, the gradation of the image displayed on the liquid crystal panel 11 is not significantly different from the gradation of the input video signal.

However, in general, when the gradation of the image in the display surface is significantly changed in each display frame, flicker easily occurs. For this, in the viewing angle improvement circuit 12 in this embodiment, as described above, the high-gradation image and the low-gradation image are displayed by the pixels adjacent to each other, and the high-gradation display and the low-gradation display are switched between the pixels at each display frame. Therefore, the occurrence of flicker on the entire display can be suppressed.

However, in a general liquid crystal panel, in addition to the above-described viewing angle improvement control, in order to prevent burn-in of liquid crystals in the liquid crystal panel, polarity inversion drive for inverting polarity at each display frame is performed. For example, as illustrated in FIG. 3, when the polarity inversion is performed every two lines of the liquid crystal panel 11, there may be cases where the pixels which perform the high-gradation display always have positive polarity in the two lines of the upper half in FIG. 3 and always have negative polarity in the two lines of the lower half in FIG. 3. In this case, the brightness of the image is slightly different between the two lines of the upper half and the two lines of the lower half of FIG. 3, and the difference in the brightness is shown as horizontal lines in the display surface of the liquid crystal panel 11. That is, in the case of FIG. 3, banding occurs in the liquid crystal panel 11.

In order to suppress the harmful effects such as flicker and banding which occur due to the viewing angle improvement control as much as possible, in the viewing angle improvement circuit 12 of this embodiment, pixels which display intermediate colors that show a significant viewing angle improvement effect are extracted, and the viewing angle improvement control is performed only on the extracted pixels. That is, in the viewing angle improvement circuit 12 of this embodiment, the viewing angle improvement control is not performed on pixels which display pure colors or a white color that has a low viewing angle improvement effect.

Specifically, as illustrated in FIG. 1, the viewing angle improvement circuit 12 includes an HSV conversion unit 21 which performs HSV analysis on the basis of the input video signal and a processing object determination unit 22 which determines whether or not a pixel displays an intermediate color by using the HSV analysis result. In addition, the viewing angle improvement circuit 12 includes a gradation conversion unit 23 which converts gradation into a higher gradation or a lower gradation than the gradation of the input video when it is determined that the image having the intermediate color is displayed, and a drive control unit 24 which outputs a video signal for performing the above-described viewing angle improvement control by using the gradation conversion result. In addition, the gradation conversion unit 23 and the drive control unit 24 constitute a viewing angle improvement unit 25.

The HSV conversion unit 21 calculates an HSV signal from an RGB signal included in the input video signal. Here, H represents hue, S represents saturation, and V represents value. In addition, a color having a higher saturation S is close to a pure color, and a color having the highest saturation S is the pure color of the hue thereof.

The hue H, the saturation S, and the value V are obtained by the following relational expressions. In addition, in the following relational expressions, gradation levels may be directly input to R, G, and B for calculation, or the gradation levels may be converted so that the minimum values thereof are 0 and the maximum values are 1 for the calculation. In addition, among the values of R, G, and B, the maximum value is denoted by MAX, and the minimum value is denoted by MIN.

$$\begin{matrix}H = 60 \times ( G - B ) / ( MAX - MIN ) + 0 & ( when MAX = R ) \\ = 60 \times ( B - R ) / ( MAX - MIN ) + 120 & ( when MAX = G ) \\ = 60 \times ( R - G ) / ( MAX - MIN ) + 240 & ( when MAX = B )\end{matrix}$$

$$S = ( MAX - MIN ) / MAX$$

$$V = MAX$$

The processing object determination unit 22 determines whether or not the image displayed by each pixel has the intermediate color on the basis of the saturation S obtained by the HSV conversion unit 21. Specifically, the processing object determination unit 22 includes a saturation determination unit 26 which determines whether or not the saturation S obtained by the HSV conversion unit 21 is smaller than a threshold and when it is determined that the saturation S is smaller than the threshold, determines that the pixel displays the image having the intermediate color. In addition, the threshold is configured to be a saturation at which a change in color can be suppressed by performing the viewing angle improvement control. In addition, in this embodiment, the value of the saturation S corresponds to a weighting coefficient of the saturation S.

The gradation conversion unit 23 converts the gradation of the input video signal into the gradation at which the viewing angle can be improved, in the pixel determined by the processing object determination unit 22 such that the pixel displays the image having the intermediate color. That is, the gradation conversion unit 23 generates a gradation higher than and a gradation lower than the gradation of the input video in order to perform the viewing angle improvement control as illustrated in FIG. 3 on the pixel determined by the processing object determination unit 22 such that the pixel displays the image having the intermediate color.

The drive control unit 24 outputs a video signal for performing the viewing angle improvement control on the pixel which displays the image having the intermediate color, by using the gradation converted by the gradation conversion unit 23. That is, the drive control unit 24 outputs the video signal for performing the viewing angle improvement control as illustrated in FIG. 3 described above to the liquid crystal panel 11.

An operational flow in which the viewing angle improvement is performed in the viewing angle improvement circuit 12 on the basis of the intermediate color determination result is illustrated in FIG. 4. As illustrated in FIG. 4, when an RGB signal is input to the viewing angle improvement circuit 12 as the input video signal (Step SA1), the processing object determination unit 22 determines whether or not each pixel displays an image having intermediate color (Step SA2).

The gradation conversion unit 23 converts the gradation of the image of the pixel determined by the processing object determination unit 22 such that the pixel displays the image having the intermediate color. In addition, an output video signal for performing the viewing angle improvement control as illustrated in FIG. 3 is output from the drive control unit 24 (Steps SA3 and SA4).

In contrast, the output video signal is output without performing the viewing angle improvement control on the pixel determined by the processing object determination unit 22 such that the pixel displays an image having a color (a pure color or a white color) other than the intermediate color.

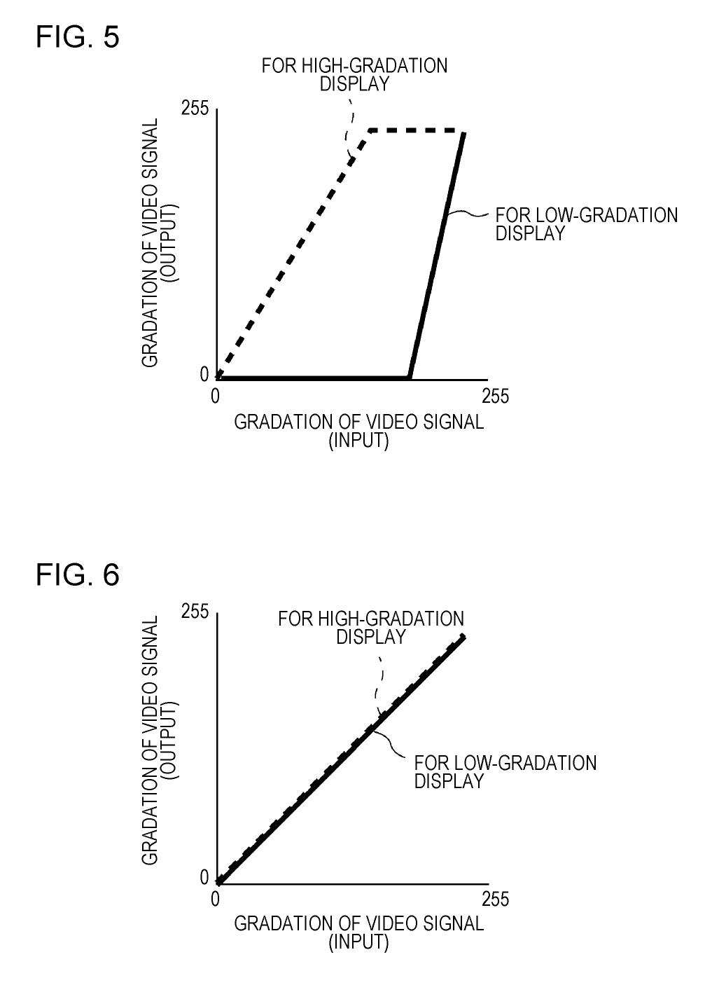

In the above-described configuration, for the pixel determined by the processing object determination unit 22 such that the pixel displays the image having the intermediate color, the gradation conversion unit 23 performs the gradation conversion so that the gradation of the input video signal (input gradation) and the gradation of the output video signal (output gradation) have, for example, the relationship illustrated in FIG. 5. That is, as illustrated in FIG. 3, in the pixel which displays the intermediate color, a case where a low-gradation image is displayed and a case where a high-gradation image is displayed are switched by the viewing angle improvement control at each display frame. In addition, in the case where the low-gradation image is displayed, the gradation of the input video signal is converted on the basis of the relationship indicated by the solid line in FIG. 5. In contrast, in the case where the high-gradation image is displayed, the gradation of the input video signal is converted on the basis of the relationship indicated by the broken line in FIG. 5.

Accordingly, in the pixel which displays the intermediate color of which the color is changed when the display surface is viewed at an inclination, the viewing angle characteristics can be improved.

In contrast, in the pixel determined by the processing object determination unit 22 such that the pixel displays a pure color or a white color, the gradation of the input video signal is output from the gradation conversion unit 23 as substantially the same gradation as illustrated in FIG. 6. That is, in the pixel which displays the pure color or the white color, the viewing angle improvement control as illustrated in FIG. 3 is not performed.

Accordingly, in the pixel which displays the pure color or the white color of which the color is not substantially changed even when the display surface is viewed at an inclination, the harmful effects such as flicker and banding caused by the viewing angle improvement control can be prevented.

### (Effect of First Embodiment)

In this embodiment, the viewing angle improvement control is performed on the pixel which displays the intermediate color of which the color is changed when the display surface is viewed at an inclination, while the viewing angle improvement control is not performed on the pixel which displays the pure color or the white color. Accordingly, while the viewing angle improvement is performed on the part having the intermediate color having a high viewing angle improvement effect, the harmful effects on the part having the pure color or the white color having a low viewing angle improvement effect due to the viewing angle improvement can be suppressed.

Therefore, according to the configuration of this embodiment, the viewing angle improvement effect can be efficiently obtained, and the harmful effects caused by the viewing angle improvement can be suppressed as much as possible.

### Second Embodiment

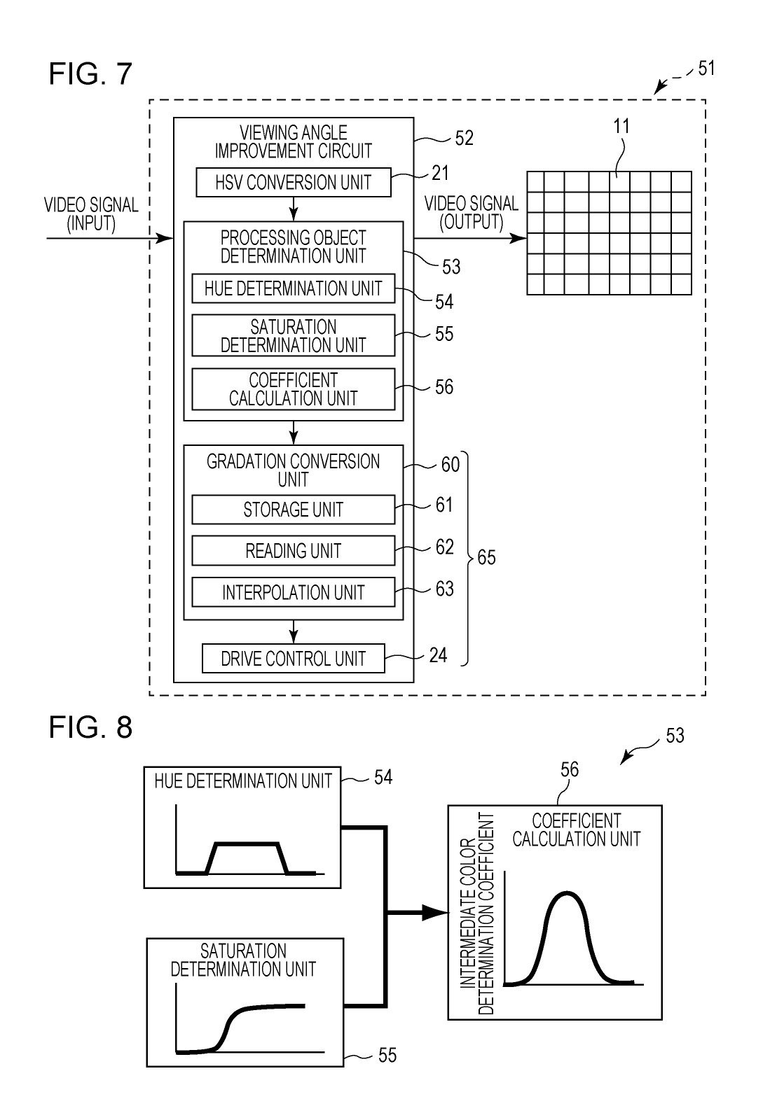

FIG. 7 illustrates a schematic configuration of a liquid crystal display apparatus 51 according to a second embodiment of the present invention. This embodiment is different from the first embodiment in that an intermediate color determination coefficient is obtained according to the hue and the saturation of an intermediate color, and gradation conversion is performed according to the intermediate color determination coefficient. In the following description, only differences from the configuration of the first embodiment are described, like elements as those of the first embodiment are denoted by like reference numerals, and the description thereof will be omitted.

Specifically, as illustrated in FIG. 7, the liquid crystal display apparatus 51 includes a viewing angle improvement circuit 52 which performs viewing angle improvement control on a pixel which displays an image having an intermediate color. The viewing angle improvement circuit 52 includes the HSV conversion unit 21 and the drive control unit 24 which have the same configurations as those of the first embodiment, a processing object determination unit 53 which calculates an intermediate color determination coefficient (weighting coefficient) depending on a processing object on the basis of hue H and saturation S, and a gradation conversion unit 60 which performs gradation conversion on the basis of the intermediate color determination coefficient.

In addition, the intermediate color determination coefficient calculated by the processing object determination unit 53 is changed according to the hue H and the saturation S, and becomes zero in a case of a single color or a white color which is not the object of the viewing angle improvement processing. In this manner, the processing object determination unit 53 indirectly selects an object to be subjected to the viewing angle improvement processing by configuring the intermediate color determination coefficient on the basis of the hue H and the saturation S. Even in this embodiment as the first embodiment described above, the gradation conversion unit 60 and the drive control unit 24 constitute a viewing angle improvement unit 65.

The processing object determination unit 53 calculates the intermediate color determination coefficient by using weight functions respectively corresponding to the hue H and the saturation S from an HSV signal converted by the HSV conversion unit 21 from an RGB signal. Specifically, as illustrated in FIG. 8, the processing object determination unit 53 includes a hue determination unit 54 which obtains the weight function according to the hue H, a saturation determination unit 55 which obtains the weight function according to the saturation S, and a coefficient calculation unit 56 which calculates the intermediate color determination coefficient by multiplying the values of the weight functions.

In the hue determination unit 54, for example, the value of the weight function is configured to a certain value so that the viewing angle improvement control is performed in a case where an image having a specific hue is displayed. The specific hue means a hue of color (so-called memory color) which remains in a human's memory, such as skin color. In addition, in the hue determination unit 54, the value of the weight function for a hue which does not need the viewing angle improvement control is zero.

The hue determination unit 54 outputs the value of the weight function according to the hue H of an input video signal.

In the saturation determination unit 55, the value of the weight function is configured to substantially zero so that the viewing angle improvement control is not performed in a case where an image having the white color is displayed, while the value of the weight function is configured so that a gradation width changed by the viewing angle improvement is gradually increased as the saturation is increased. In addition, in the saturation determination unit 55, in a case of a pure color having the highest saturation, the weight function is zero.

The saturation determination unit 55 outputs the value of the weight function according to the saturation S of the video signal which is input.

The coefficient calculation unit 56 calculates the intermediate color determination coefficient by multiplying the values respectively output from the hue determination unit 54 and the saturation determination unit 55. That is, the intermediate color determination coefficient is a value changed according to the hue and the saturation. In addition, as described later, the intermediate color determination coefficient is a value used when the gradation of the input video signal is converted into the gradation of a video signal output to the liquid crystal panel 11. In addition, as described above, in the hue determination unit 54, the value of the weight function is zero in the case of a hue which does not need the viewing angle improvement control, and in the saturation determination unit 55, the value of the weight function is zero in the case of a pure color or a white color. Therefore, the intermediate color determination coefficient becomes zero in the cases of the hue which does not need the viewing angle improvement control, pure color, and white color.

The gradation conversion unit 60 includes a storage unit 61 which stores the relationship between the gradation of the input video signal and the gradation of the output video signal according to the intermediate color determination coefficient as table data. Furthermore, the gradation conversion unit 60 includes a reading unit 62 which outputs a corresponding signal from the storage unit 61 on the basis of the intermediate color determination coefficient calculated by the processing object determination unit 53 and the gradation of the input video signal, and an interpolation unit 63 which corrects the signal output from the reading unit 62 by linear interpolation.

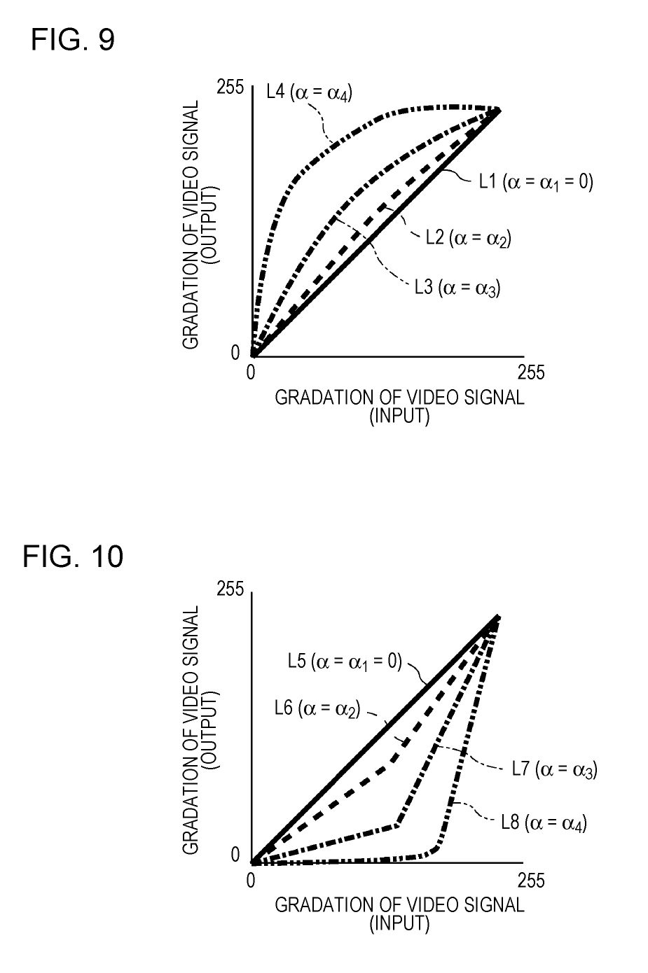

The storage unit 61 stores the relationship between the gradation of the input video signal and the gradation of the output video signal according to the intermediate color determination coefficient as the table data as illustrated in FIGS. 9 and 10. The table data is data of gradations corresponding to several intermediate color determination coefficients, and is stored in the storage unit 61 as discrete values. Accordingly, since the relationship between the gradation of the input video signal and the gradation of the output video signal according to the intermediate color determination coefficient is stored in the storage unit 61 as the discrete values, the amount of data stored in the storage unit 61 can be reduced compared to a case where the entire data is stored.

In addition, FIGS. 9 and 10 are diagrams of graphs in which parts of the table data stored in the storage unit 61 are connected with lines. Hereinafter, the table data stored in the storage unit 61 will be described with reference to FIGS. 9 and 10.

As illustrated in FIGS. 9 and 10, in the case where the intermediate color determination coefficient α is zero, that is, in the case of a hue and a saturation which do not need the viewing angle improvement, the gradation of the input video signal becomes the gradation of the output video signal (L1 in FIG. 9 and L5 in FIG. 10) almost as it is. In contrast, in the case where the intermediate color determination coefficient α is not zero, according to the intermediate color determination coefficient α, the relationship between the gradation of the input video signal and the gradation of the output video signal is changed as shown from L2 to L4 and from L6 to L8. That is, in the case where the intermediate color determination coefficient α is not zero, even from the gradation of the same input video signal, the gradation of the output video signal is increased or decreased according to the intermediate color determination coefficient α. Particularly, when the gradation of the input video signal is in the range of intermediate gradations, the gradation of the output video signal is significantly increased or decreased according to the intermediate color determination coefficient α. In addition, in FIGS. 9 and 10, the relationship of α₁<α₂<α₃<α₄ is satisfied.

FIG. 9 illustrates the relationship between the gradation of the input video signal and the gradation of the output video signal in the case where the high-gradation display for the viewing angle improvement control illustrated in FIG. 3 is performed. In FIG. 9, in the order of L2, L3, and L4, changes in gradation during the viewing angle improvement control are increased. In addition, as illustrated in FIG. 9, the relationship between the gradation of the input video signal and the gradation of the output video signal is a relationship in which the gradation of the output video signal is higher than the gradation of the input video signal by an extent to which the intermediate color determination coefficient α is increased when the gradation of the input video signal is in the range of intermediate gradations.

FIG. 10 illustrates the relationship between the gradation of the input video signal and the gradation of the output video signal in the case where the low-gradation display for the viewing angle improvement control illustrated in FIG. 3 is performed. In FIG. 10, in the order of L6, L7, and L8, changes in gradation during the viewing angle improvement control is increased. In addition, as illustrated in FIG. 10, the relationship between the gradation of the input video signal and the gradation of the output video signal is a relationship in which the gradation of the output video signal is lower than the gradation of the input video signal by an extent to which the intermediate color determination coefficient α is increased when the gradation of the input video signal is in the range of intermediate gradations.

In addition, during the viewing angle improvement control illustrated in FIG. 3, the gradation conversion is performed according to the gradation relationship (the relationship between the gradation of the input video signal and the gradation of the output video signal) calculated by using the same intermediate color determination coefficient α for the high-gradation display and the low-gradation display. That is, for example, in the case of FIGS. 9 and 10, L1 and L5, L2 and L6, L3 and L7, and L4 and L8 are respectively used for the gradation conversion for the high-gradation display and the low-gradation display during the viewing angle improvement control.

As described above, in FIG. 9, since the changes in gradation during the viewing angle improvement control are increased in the order of L2, L3, and L4 (in the order of L6, L7, and L8 in FIG. 10), the viewing angle improvement effect is increased in the order. In contrast, since the changes in gradation during the viewing angle improvement control are increased in the order of L2, L3, and L4 (in the order of L6, L7, and L8 in FIG. 10), the harmful effects such as flicker caused by the viewing angle improvement are increased.

In addition, in FIGS. 9 and 10, only three curves are drawn to show the relationship in the case where the intermediate color determination coefficient is considered. However, in practice, the storage unit 61 stores the relationship between the gradation of the input video signal and the gradation of the output video signal according to various intermediate color determination coefficients as the table data.

The reading unit 62 reads a plurality of pieces of data close to the intermediate color determination coefficient and the gradation of the input video signal from the table data stored in the storage unit 61 on the basis of the intermediate color determination coefficient calculated by the processing object determination unit 53 and the gradation of the input video signal. At this time, the data read by the reading unit 62 is the discrete value of the intermediate color determination coefficient and the gradations of the input and output video signals.

In addition, when the reading unit 62 reads the data, a plurality of pieces of data in each of a case where a display having a higher gradation than the gradation of the input image is performed and a case where a display having lower gradation than the gradation of the input image is performed is read out so that the viewing angle improvement control illustrated in FIG. 3 can be realized.

The interpolation unit 63 individually performs linear interpolation in the case of the high-gradation display and in the case of the low-gradation display by using the intermediate color determination coefficient calculated by the processing object determination unit 53, the gradation of the input video signal, and the plurality of pieces of data read by the reading unit 62. Specifically, in the interpolation unit 63, by using the relationship illustrated in FIGS. 9 and 10 in which the gradation of the output video signal is more significantly changed with respect to the gradation of the input video signal by an extent to which the intermediate color determination coefficient α is increased, the gradation of the output video signal corresponding to the gradation of the input video signal in the case of the calculated intermediate color determination coefficient is obtained. More specifically, on the basis of the data read by the reading unit 62, the relationship between the gradation of the input video signal and the gradation of the output video signal in the case of the calculated intermediate color determination coefficient is obtained by the linear interpolation, and the gradation of the output video signal corresponding to the actual input video signal is obtained from the result. Accordingly, while considering the intermediate color determination coefficient, the gradation of the output video signal corresponding to the actual input video signal can be approximately obtained.

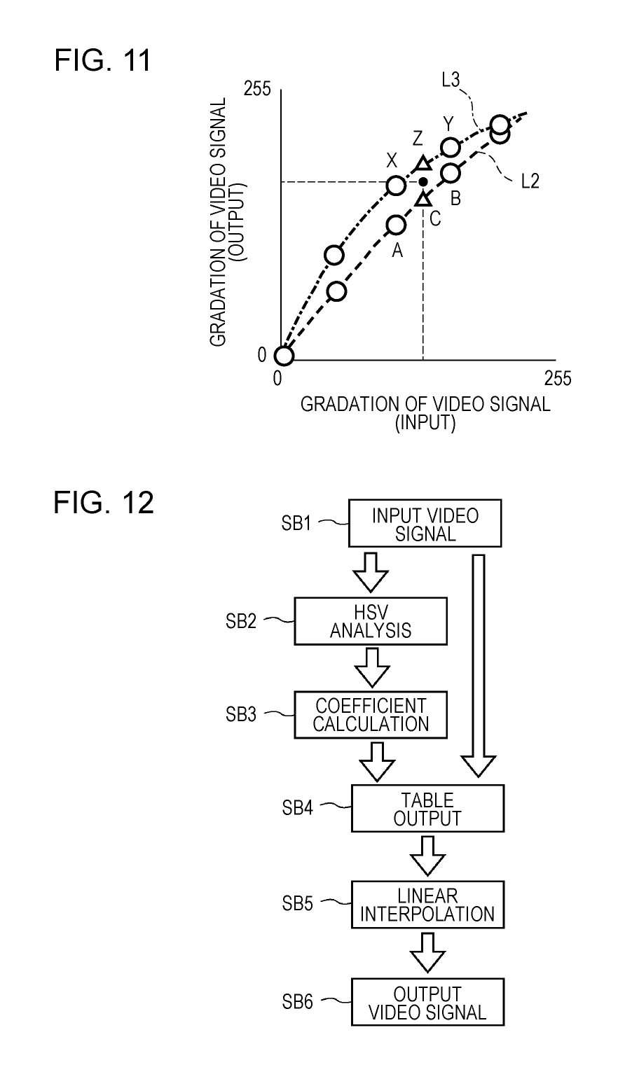

FIG. 11 illustrates an example of the case where the gradation of the output video signal corresponding to the input video signal is obtained through the linear interpolation. In the example of FIG. 11, when the graphs of L2 and L3 are given by several pieces of data (white circles in the figure), the gradation of the output video signal at the black circle is obtained through the linear interpolation. First, for L2, by performing the linear interpolation between data A and B, the gradation of the output video signal at the point C corresponding to the gradation of the input video signal at the black circle is obtained. Next, for L3, by performing the linear interpolation between data X and Y, the gradation of the output video signal at the point Z corresponding to the gradation of the input video signal at the black circle is obtained. In addition, by using the intermediate color determination coefficients of L2 and L3 and the gradations of the output video signal obtained at the points C and Z, the gradation of the output video signal at the black circle is obtained through the linear interpolation. In addition, the expression of the linear interpolation is a general expression in which the coordinates of both ends on a straight line are used to obtain the coordinates of an intermediate point positioned on the straight line, and thus the detailed description thereof will be omitted.

FIG. 12 schematically illustrates the operations of the viewing angle improvement circuit 52. First, when the input video signal is input to the viewing angle improvement circuit 52 (Step SB1), the HSV conversion unit 21 performs HSV analysis by using the input video signal (Step SB2). Since the HSV analysis is the same as in the first embodiment, the detailed description thereof will be omitted. On the basis of the HSV signal converted from the RGB signal by the HSV conversion unit 21, the processing object determination unit 53 calculates the intermediate color determination coefficient (Step SB3).

By using the calculated intermediate color determination coefficient and the gradation of the input video signal, the table data is read from the storage unit 61 of the gradation conversion unit 60 (Step SB4). The interpolation unit 63 approximately obtains the gradation of the output video signal by using the read data through the linear interpolation (Step SB5). According to the obtained gradation, as in the first embodiment, the output video signal is output from the drive control unit 24 to the liquid crystal panel 11 (Step SB6).

### (Effects of Second Embodiment)

In this embodiment, the gradation of the input image signal is converted by using the intermediate color determination coefficient considering hue and saturation. Therefore, the viewing angle improvement control can be performed according to hue and saturation. That is, in the configuration of this embodiment, in the case where an image having a hue or a saturation of which the color is significantly changed when the display screen is viewed at an inclination, the viewing angle improvement control may be preferentially performed by significantly changing the gradation. In contrast, in the case of a hue and a saturation for which the viewing angle improvement does not necessarily need to be performed, changes in gradation for the viewing angle improvement are reduced, thereby preventing the harmful effects caused by the viewing angle improvement control.

In addition, the storage unit 61 of the gradation conversion unit 60 stores the relationship between the gradation of the input video signal and the gradation of the output video signal according to the weight functions as the table data. Furthermore, the interpolation unit 63 approximately obtains the gradation of the output video signal by performing the linear interpolation on the data read from the table data. In this configuration, the storage unit 61 does not need to store much data, and thus the capacity of the memory provided in the liquid crystal display apparatus can be reduced.

### Third Embodiment

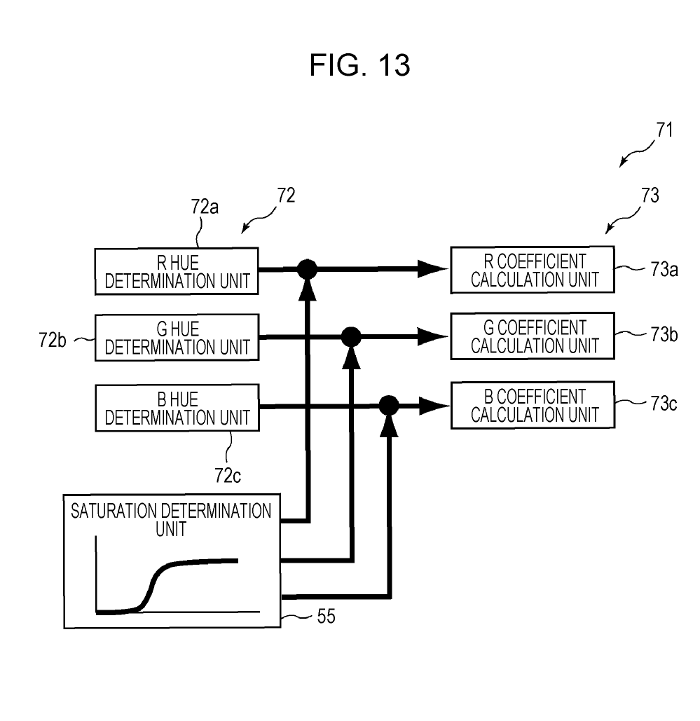

FIG. 13 is a block diagram of a schematic configuration of a processing object determination unit 71 in a viewing angle improvement circuit of a liquid crystal display apparatus according to a third embodiment of the present invention. The configuration of this embodiment is different from the configuration of the second embodiment in that an intermediate color determination coefficient is configured to correspond to each of R, G, and B sub-pixels included in a pixel of the liquid crystal panel 11. In the following description, like configurations as those of the second embodiment are denoted by like reference numerals, and only the differences will be described.

Specifically, as illustrated in FIG. 13, a hue determination unit 72 of the processing object determination unit 71 includes an R hue determination unit 72a, a G hue determination unit 72b, and a B hue determination unit 72c. In addition, a coefficient calculation unit 73 of the processing object determination unit 71 includes an R coefficient calculation unit 73a, a G coefficient calculation unit 73b, and a B coefficient calculation unit 73c.

The R hue determination unit 72a, the G hue determination unit 72b, and the B hue determination unit 72c have table data of weight functions corresponding to their respective colors. For example, the R hue determination unit 72a has the table data in which the value of the weight function is zero in a case of a single color of red. The G hue determination unit 72b has the table data in which the value of the weight function is zero in a case of a single color of green. The B hue determination unit 72c has the table data in which the value of the weight function is zero in a case of a single color of blue. The R hue determination unit 72a, the G hue determination unit 72b, and the B hue determination unit 72c output the values of the weight functions corresponding to hues of their respective colors.

The R coefficient calculation unit 73a, the G coefficient calculation unit 73b, and the B coefficient calculation unit 73c calculates the intermediate color determination coefficients corresponding to their respective colors by respectively using the outputs of the R hue determination unit 72a, the G hue determination unit 72b, and the B hue determination unit 72c and the output of the saturation determination unit 55. That is, the R coefficient calculation unit 73a obtains an R intermediate color determination coefficient by multiplying the value of the weight function output from the R hue determination unit 72a by the value of the weight function output from the saturation determination unit 55. The G coefficient calculation unit 73b obtains a G intermediate color determination coefficient by multiplying the value of the weight function output from the G hue determination unit 72b by the value of the weight function output from the saturation determination unit 55. The B coefficient calculation unit 73c obtains a B intermediate color determination coefficient by multiplying the value of the weight function output from the B hue determination unit 72c by the value of the weight function output from the saturation determination unit 55.

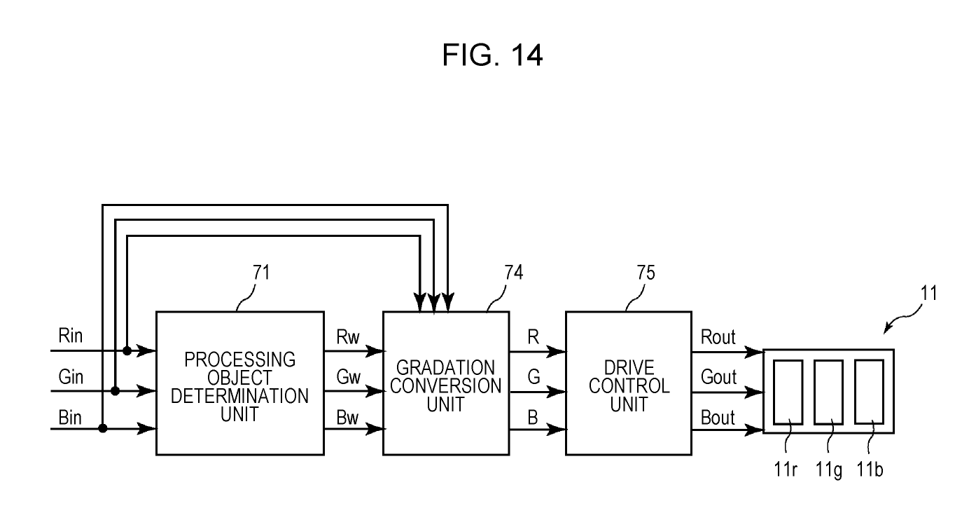

FIG. 14 schematically illustrates a flow of signals in a case where the gradation conversion is performed on each of R, G, and B sub-pixels 11r, 11g, and 11b. In addition, in FIG. 14, the description of the HSV conversion is omitted.

Intermediate color determination coefficients Rw, Gw, and Bw which are obtained from the input video signals Rin, Gin, and Bin by the processing object determination unit 71 having the above configuration are input to a gradation conversion unit 74. The gradation conversion unit 74 performs the gradation conversion according to each of the R, G, and B sub-pixels 11r, 11g, and 11b. The content of the gradation conversion is the same as in the second embodiment, and thus the detailed description thereof will be omitted. In addition, a drive control unit 75 generates output video signals Rout, Gout, and Bout respectively corresponding to the sub-pixels 11r, 11g, and 11b. The generated output video signals Rout, Gout, and Bout are respectively output to the sub-pixels 11r, 11g, and 11b of the liquid crystal panel 11.

Therefore, in this embodiment, the output video signals Rout, Gout, and Bout which are independently subjected to the gradation conversion are output to the R, G, and B sub-pixels 11r, 11g, and 11b of the liquid crystal panel 11. Therefore, in the R, G, and B sub-pixels 11r, 11g, and 11b, whether or not the viewing angle improvement control is performed and the degree of gradation conversion vary.

### (Effects of Third Embodiment)

In this embodiment, the intermediate color determination coefficient for each of R, G, and B is obtained, and the gradation conversion is individually performed on the R, G, and B sub-pixels 11r, 11g, and 11b. Accordingly, while the optimum viewing angle improvement control is performed in consideration of hue and saturation in each of the R, G, and B sub-pixels 11r, 11g, and 11b, the harmful effects caused by the viewing angle improvement control on the part having a low viewing angle improvement effect can be suppressed.

### Other Embodiments

While the embodiments of the present invention have been described, the above-described embodiments are only examples for embodying the present invention. Therefore, the present invention is not limited to the above-described embodiments, and the above-described embodiments can be appropriately modified without departing from the gist of the present invention.

In the first embodiment, as illustrated in FIG. 5, the viewing angle improvement circuit 12 converts the gradation of the video signal into gradations for the high-gradation display and the low-gradation display with regard to the pixel which displays the intermediate color regardless of saturation so as to be output. However, the viewing angle improvement circuit 12 may be configured to determine a weighting coefficient according to the saturation and perform the gradation conversion according to the weighting coefficient. In this case, similarly to the saturation determination unit 55 illustrated in FIG. 8, the saturation determination unit 26 is configured to determine the weighting coefficient according to the saturation. In addition, the gradation conversion unit 23 is configured to perform the gradation conversion in consideration of the weighting coefficient. Accordingly, as in FIGS. 9 and 10, the gradations for the high-gradation display and the low-gradation display in the pixel which displays the intermediate color can be changed according to the saturation.

In the second embodiment, the storage unit 61 of the gradation conversion unit 60 stores only the discrete values regarding the gradation conversion according to the intermediate color determination coefficients, and the interpolation unit 63 performs the linear interpolation according to the actual intermediate color determination coefficient and the gradation of the input video signal. However, in the storage unit 61, all data representing the relationship between the gradation of the input video signal and the gradation of the output video signal according to the intermediate color determination coefficients may be stored so that the linear interpolation is not performed.

In the second and third embodiments, the coefficient calculation units 56 and 73 are configured to determine the intermediate color determination coefficients by using the saturation and hue of an image. However, the coefficient calculation unit may be configured to determine the intermediate color determination coefficient according to a detection result of an edge of the image. That is, the coefficient calculation unit in this case configures the intermediate color determination coefficient so that the viewing angle improvement processing is not performed on the edge part of the image.

### INDUSTRIAL APPLICABILITY

The liquid crystal display apparatus according to the present invention can be used for a liquid crystal display apparatus which performs viewing angle improvement.

1. A liquid crystal display apparatus comprising:
a liquid crystal panel which includes a plurality of pixels arranged in a matrix;
a viewing angle improvement unit which performs a high-gradation display to display an image having a higher gradation than a gradation of an input video on one pixel of pixels adjacent to each other, performs a low-gradation display to display an image having a lower gradation than the gradation of the input video on the other pixel of the pixels adjacent to each other, and switches between the high-gradation display and the low-gradation display on each of the pixels in each display frame to perform viewing angle improvement processing; and
a processing object determination unit which determines whether or not an image displayed on each of the pixels of the liquid crystal panel is an image having an intermediate color which is an object of the viewing angle improvement processing,
wherein the viewing angle improvement unit is configured to perform the viewing angle improvement processing on the pixel determined by the processing object determination unit such that the pixel displays the image having the intermediate color.

2. The liquid crystal display apparatus according to claim 1,
wherein the processing object determination unit determines whether or not the image has the intermediate color on the basis of a weighting coefficient according to the image displayed on each of the pixels.

3. The liquid crystal display apparatus according to claim 2,
wherein the weighting coefficient is a coefficient according to saturation obtained from a video signal input to each of the pixels of the liquid crystal panel, and
the processing object determination unit includes a saturation determination unit which determines whether or not the image has the intermediate color on the basis of the weighting coefficient.

4. The liquid crystal display apparatus according to claim 3,
wherein the viewing angle improvement unit includes:
a gradation conversion unit which obtains output gradations for the high-gradation display and the low-gradation display according to the saturation for the pixel determined by the processing object determination unit such that the pixel displays the image having the intermediate color; and
a drive control unit which performs the viewing angle improvement processing according to the output gradations output from the gradation conversion unit.

5. The liquid crystal display apparatus according to claim 2,
wherein the weighting coefficient is a coefficient according to saturation and hue obtained from a video signal input to each of the pixels of the liquid crystal panel,
the processing object determination unit is configured to determine whether or not the image has the intermediate color of a hue of the object of the viewing angle improvement processing on the basis of the weighting coefficient, and
the viewing angle improvement unit performs the viewing angle improvement processing on the pixel which displays the image having the intermediate color of the hue of the object of the viewing angle improvement processing on the basis of the determination result of the processing object determination unit.

6. The liquid crystal display apparatus according to claim 5,
wherein the weighting coefficient is an intermediate color determination coefficient,
the processing object determination unit further includes a coefficient calculation unit which obtains the intermediate color determination coefficient on the basis of the saturation and the hue, and
the viewing angle improvement unit includes:
a gradation conversion unit which respectively obtains output gradations for the high-gradation display and the low-gradation display by using the intermediate color determination coefficient; and
a drive control unit which performs the viewing angle improvement processing according to the output gradations output from the gradation conversion unit.

7. (canceled)

8. A liquid crystal display apparatus comprising:
a liquid crystal panel which includes a plurality of pixels arranged in a matrix, each of the pixels including a plurality of sub-pixels,
a viewing angle improvement unit which performs a high-gradation display to display an image having a higher gradation than a gradation of an input video on one sub-pixel of the sub-pixels adjacent to each other, performs a low-gradation display to display an image having a lower gradation than the gradation of the input video on the other sub-pixel, and switches between the high-gradation display and the low-gradation display on each of the sub-pixels in each display frame to perform viewing angle improvement processing; and
a processing object determination unit which determines whether an image displayed on each of the sub-pixels of the liquid crystal panel is an image having an intermediate color which is an object of the viewing angle improvement processing,
wherein the viewing angle improvement unit is configured to perform the viewing angle improvement processing on the sub-pixel determined by the processing object determination unit such that the sub-pixel displays the image having the intermediate color.
